(19) United States
(12) Patent Application Publication
(10) Pub. No.: US 2025/0097758 A1
(43) Pub. Date: Mar. 20, 2025

(54) REDUCING USER EQUIPMENT (UE) MEASUREMENT OVERHEAD BY USING AN EXTERNAL SOURCE

(71) Applicant: QUALCOMM Incorporated, San Diego, CA (US)

(72) Inventor: Shijun WU, San Diego, CA (US)

(21) Appl. No.: 18/471,272

(22) Filed: Sep. 20, 2023

(51) Int. Cl. H04W 28/02; H04W 28/18

(52) U.S. Cl. CPC H04W 28/0215; H04W 28/0226; H04W 28/18

(57) ABSTRACT

Methods, systems, and devices for reducing user equipment (UE measurement overhead by using an external source are described. A UE or a network may be capable of obtaining location-specific cell coverage information from an external source (such as a coverage map or a database). The network may use the coverage information to configure a measurement gap for the UE. For example, the UE may be located in a cell with relatively high coverage quality compared to that of a neighboring cell, according to the external source. Based on the relative coverage quality, the network may reduce the periodicity of the UE measurements, change the measurement gap to be aperiodic, or configure the UE to refrain from measuring.

### FIELD OF TECHNOLOGY

The following relates to wireless communication, including reducing user equipment (UE) measurement overhead by using an external source.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

A network entity may configure a UE with a measurement gap. A measurement gap may correspond to resources allocated for the UE to measure signal quality information for a downlink signal. The downlink signal may be associated with a network entity of a current cell of the UE or a downlink signal associated with a network entity of a neighboring cell.

### SUMMARY

The described techniques relate to improved methods, systems, devices, and apparatuses that support reducing user equipment (UE) measurement overhead by using an external source. For example, the described techniques provide for reducing redundant UE coverage measurements. In some examples, a network entity has access to the external source, in other examples the UE has access to the external source and may relay coverage information to the network entity. Either the network entity or the UE may trigger a measurement gap configuration. The network entity determine a measurement gap based on the coverage information from the external source. The network entity may increase or decrease the periodicity of the measurement gap, configure an aperiodic measurement gap, or refrain from configuring a measurement gap (e.g., tell the UE not to measure) in response to relative signal information of a serving cell compared to one or more neighboring cells. Referencing the external source to adjust the measurement gap results in increased communication between the serving cell and the UE, while maintaining adequate coverage. The increased communication between the serving cell and the UE reduces latency.

### BRIEF DESCRIPTION OF THE DRAWINGS

FIGS. 1 and 2 show examples of wireless communications systems that support reducing user equipment (UE) measurement overhead by using an external source in accordance with one or more aspects of the present disclosure.

FIG. 3 shows an example of a coverage map that supports reducing UE measurement overhead by using an external source in accordance with one or more aspects of the present disclosure.

FIGS. 4 and 5 show examples of process flows that support reducing UE measurement overhead by using an external source in accordance with one or more aspects of the present disclosure.

FIGS. 6 through 9 show flowcharts illustrating methods that support reducing UE measurement overhead by using an external source in accordance with one or more aspects of the present disclosure.

### DETAILED DESCRIPTION

The following description is directed to some implementations for the purposes of describing the innovative aspects of this disclosure. However, a person having ordinary skill in the art will readily recognize that the teachings herein can be applied in a multitude of different ways. The described implementations may be implemented in any device, system, or network that is capable of transmitting and receiving radio frequency (RF) signals according to any of the Institute of Electrical and Electronics Engineers (IEEE) 16.11 standards, or any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing third generation (3G), fourth generation (4G) or fifth generation (5G), sixth generation (6G), or further implementations thereof, technology.

Network coverage may not be uniform or available everywhere. A user equipment (UE) may be unable to perform various functions when located in areas with poor coverage. For example, without network connection, a UE (e.g., a vehicle capable of autonomous driving) may be unable to perform functions such as downloading a real-time map from a cloud or a server, uploading real-time sensor data to the network, uploading UE status data to the network, etc. To ensure adequate coverage, the UE may measure signal information for neighbor carriers or cells according to a measurement gap. Measuring the signal information may improve mobility (e.g., handover) operations, carrier aggregation decisions, etc. However, the UE measurements may have high overhead and may interrupt communication between the UE and a serving cell.

In accordance with examples described herein, the overhead of measurement gaps may be reduced by referring to an external source (e.g., a coverage map, a database). The external source may contain location-specific and time-specific coverage information of the network along a travel route of the UE. In some examples, a network entity has access to the external source, in other examples the UE has access to the external source and may relay coverage information to the network entity. The network entity may reference the coverage information when determining a measurement gap. For example, if the coverage in the serving cell is above a threshold (e.g., higher quality than a neighboring cell), then the network entity may set the measurement gap such that the UE does not perform measurements for a time. In other examples, the network entity may increase or decrease the periodicity of the measurement gap in response to the relative signal quality information of the serving cell compared to one or more neighboring cells. In other examples, the network entity may configure the measurement gap configuration to be aperiodic. Referencing the external source to adjust the measurement gap configuration (e.g., reduce the periodicity of the measurement gap, configure to not perform measurements) results in the UE performing less measurements, which results in decreased measurement overhead and increased communication between the serving cell and the UE. Reduced measurement overhead may be achieved while maintaining adequate coverage and reducing power consumption. The increased (e.g., uninterrupted or less interrupted) communication between the serving cell and the UE reduces latency and improves user experience.

Aspects of the disclosure are initially described in the context of wireless communications systems. Aspects of the disclosure are also described in the context of a coverage map and in the context of process flows. Aspects of the disclosure are further illustrated by and described with reference to apparatus diagrams, system diagrams, and flowcharts that relate to reducing UE measurement overhead by using an external source.

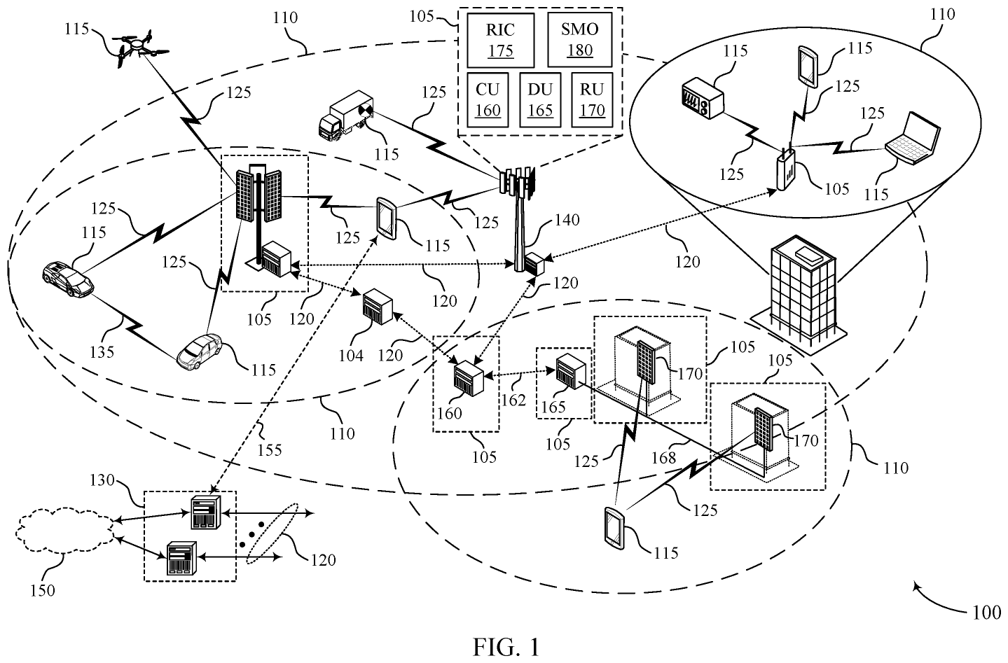

FIG. 1 shows an example of a wireless communications system 100 that supports reducing UE measurement overhead by using an external source in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support reducing UE measurement overhead by using an external source as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking. Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

Network coverage may not be uniform or available everywhere. For example, some geographical areas (e.g., roads) may not be covered by network coverage (e.g., be outside of a coverage area 110) or have poor coverage due to various reasons. Even if an area has network coverage (e.g., is inside of a coverage area 110), the coverage may not be uniform. Unavailability or variability of network coverage may negatively affect a connectivity of a UE 115 and user experience. When located in areas with poor coverage, a UE 115 may be unable to perform various functions. For example, a UE 115 (e.g., a vehicle) may be unable to perform functions related to infotainment (e.g., infotainment may rely on a vehicle being wirelessly connected to get services). As another example, a UE 115 that is capable of autonomous driving may be unable to download maps such as a real-time HD map (e.g., a map that contains details that are normally not presented in traditional digital maps, that provides precision that may not be achievable in traditional digital maps, etc.) from a cloud or a server. The UE 115 may also be unable to upload real-time sensor data or UE 115 (e.g., vehicle) status data to a network.

To ensure adequate coverage, the UE 115 (e.g., an RRC connected UE) may measure signal information for neighbor carriers or cells according to a measurement gap. Measuring the signal information may improve mobility (e.g., handover) operations, carrier aggregation decisions, etc. However, the UE 115 measurements may have high overhead and may interrupt communication between the UE 115 and a corresponding network entity 105 of a serving cell. For example, during a measurement gap, the UE 115 may tune its radio frequency towards a target cell or carrier for the measurement and, as a result, communication may be interrupted (e.g., paused) between the UE 115 and the network entity 105 associated with the serving cell during the measurement gap. For example, if a UE 115 (e.g., in NR) has a measurement gap configuration where the measurement gap is 4 ms in length and has a 20 ms periodicity (e.g., periodical measurements every 20 ms), then 20% of time may be dedicated to that measurement gap (in other words, there is a 20% overhead for measuring a single object). In some examples, communication between the UE 115 and the network entity 105 associated with the serving cell may also be interrupted during slots adjacent to the measurement gap (e.g., slots for grants and feedbacks (e.g., HARQ), etc. related to the measurement). Additionally, more carriers or cells being available at a mobile network operator (MNO), may result in more overhead from the measurements. Similarly, if the UE 115 operates at multiple frequencies, the overhead from the measurements may increase.

The overhead of measurement gaps may be reduced by referring to an external source (e.g., a coverage map, a database). An external source (e.g., a coverage map, an automotive coverage map, a database) may be a tool for network coverage prediction. For example, an external source can have location-specific and time-specific coverage information about the network (e.g., reference signal received power (RSRP) reference signal received quality (RSRQ), channel state information (CSI), or expected user experienced data rate, etc.). In some examples, the external source may be used for RAN optimization (e.g., overhead reduction, beam management, etc.). In some examples, the external source may be used to predict UE 115 (e.g., vehicle) connectivity quality along route of the UE 115. The prediction may then be used for path planning (e.g., finding a route with guaranteed network connection), pre-downloading/pre-buffering (e.g., for an HD map along the route, streaming, etc.). A route with guaranteed network connection may be valuable for tele-operated driving, for example. In some examples, a real-time location for vehicles may be readily available, which may make external sources, such as coverage maps, especially useful.

The external source may contain location-specific and time-specific coverage information of the network along a travel route of the UE 115. In other words, the communications system may reference an external source to obtain coverage information rather than measure the coverage information. In some examples, a network entity 105 has access to the external source, in other examples the UE 115 has access to the external source and may relay coverage information to the network entity 105. In some examples, both the UE 115 and the network entity 105 may have access to the external source. The coverage information may include at least information about the coverage of a neighbor cell (e.g., RSRP, RSRQ, signal to interference plus noise ratio (SINR), etc. of a neighbor cell). The coverage information may indicate coverage at the current location of the UE 115, coverage at a future location of the UE 115, or both. The future location of the UE 115 may be based on the path planning of the UE 115 (e.g., based on a navigation map).

The network entity 105 may reference the coverage information when determining a measurement gap (e.g., a measurement periodicity). For example, if the coverage in the serving cell is above a threshold (e.g., higher quality than a neighboring cell), then the network entity 105 may set the measurement gap such that the UE 115 does not perform measurements for a time. In other examples, the network entity 105 may increase or decrease the periodicity of the measurement gap in response to the relative signal information of the serving cell compared to one or more neighboring cells. In other examples, the network entity 105 may transmit an aperiodic measurement gap configuration to the UE 115. Referencing the external source to adjust the measurement gap configuration (e.g., reduce the periodicity of the measurement gap, configure to not perform measurements) results in the UE performing less measurements, which results in decreased measurement overhead and increased communication between the serving cell and the UE. Reduced measurement overhead may be achieved while maintaining adequate coverage and reducing power consumption. The increased (e.g., uninterrupted or less interrupted) communication between the serving cell and the UE reduces latency and improves user experience.

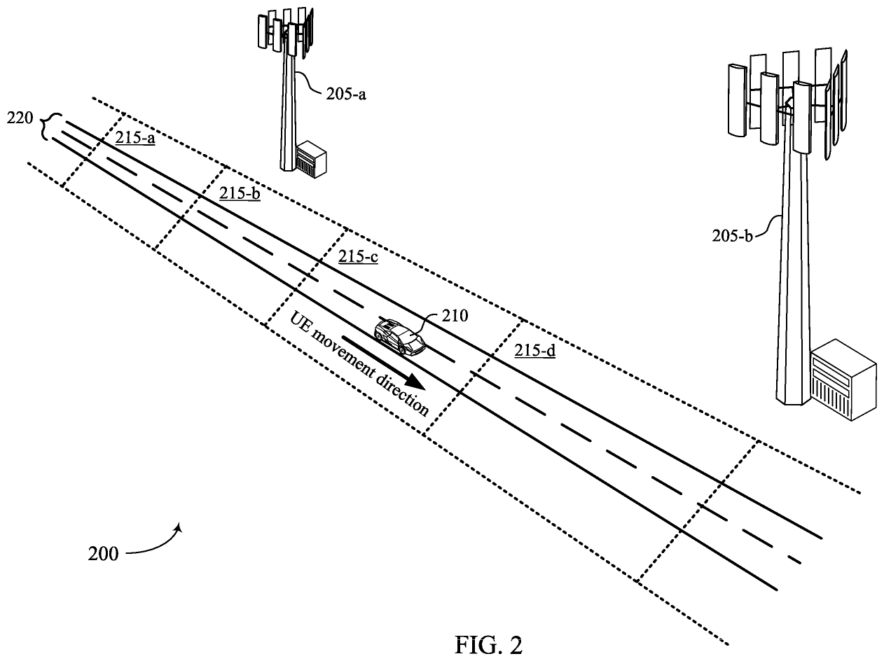

FIG. 2 shows an example of a wireless communications system 200 that supports reducing UE measurement overhead by using an external source in accordance with one or more aspects of the present disclosure. The wireless communications system 200 may implement or be implemented to realize aspects of the wireless communications system 100. The wireless communications system 200 may include network entities 205, a UE 210, locations 215 (e.g., location 215-a, 215-b, 215-c, and 215-d), and a path 220. Network entities 205 may be examples of network entities 105 and UE 210 may be an example of a UE 115. In some examples, the UE 210 may be a vehicle and the path 220 may be a road. In some examples, the path 220 includes curves, turns, changes in elevation, etc. The path 220 may be set in a city environment, countryside, desert, or any type of terrain. The path 220 may be represented by a set of locations 215. In some examples, the UE 210 may be at location 215-c and may be moving along the path 220 away from location 215-b and toward location 215-d (e.g., the UE 210 was at location 215-a at a previous moment in time and may be at location 215-d in a future moment in time). The locations 215 may be sampled locations or may be associated with geo-tagged coverage measurements.

In some examples, the UE 210 may have access to an external source (e.g., coverage map, database, etc.) corresponding to a location 215 (e.g., location 215-d) neighboring the UE 210. In some examples, the UE 210 may have access to an external source (e.g., coverage map, database, etc.) corresponding to multiple locations 215 (e.g., locations 215-a through 215-d). Location 215-c may correspond to a cell (e.g., a serving cell) associated with network entity 205-a and location 215-d may correspond to a cell (e.g., a neighbor cell) associated with network entity 205-b. A cell may be an intra-frequency cell, inter-frequency cell, intra-RAT cell, or inter-RAT cell.

In some examples, the UE 210 may indicate, to the network entity 205-a the ability of the UE 210 to access the external source. The UE 210 may obtain location-specific and time-specific coverage information from the external source. The UE 210 may compare coverage information obtained from the external source and associated with location 215-d (e.g., a future location of the UE 210) with coverage information obtained from a measurement done by the UE 210 associated with location 215-c (e.g., a current location of the UE 210). The UE 210 may compare coverage information obtained from the external source associated with location 215-d with coverage information obtained from the external source associated with location 215-c. The UE 210 may compare coverage information obtained from the external source associated with location 215-d with coverage information obtained from the external source associated with location 215-c and with coverage information obtained from a measurement done by the UE 210 (e.g., a weighted average of the two). If the coverage information associated with location 215-c indicates a higher or lower signal quality (e.g., higher or lower RSRP, RSRQ. SINR, etc.) than the coverage information associated with the location 215-d, then the UE 210 may trigger a measurement gap configuration.

In some examples, the network entity 205-a may obtain location-specific and time-specific coverage information from the external source. The network entity 205-a may compare coverage information obtained from the external source and associated with location 215-d (e.g., a future location of the UE 210) with coverage information obtained from a measurement done by the UE 210 associated with location 215-c (e.g., a current location of the UE 210). The network entity 205-a may compare coverage information obtained from the external source associated with location 215-d with coverage information obtained from the external source associated with location 215-c. The network entity 205-a may compare coverage information obtained from the external source associated with location 215-d with coverage information obtained from the external source associated with location 215-c and with coverage information obtained from a measurement done by the UE 210 (e.g., a weighted average of the two). If the coverage information associated with location 215-c indicates a higher or lower signal quality (e.g., higher or lower RSRP, RSRQ. SINR, etc.) than the coverage information associated with the location 215-d, then the network entity 205-a may trigger a measurement gap configuration.

The network entity 205-a may configure a measurement gap for the UE 210 based on the relative signal qualities of locations 215-c and 215-d. For example, if the signal quality at location 215-c is higher than the signal quality at 215-d, then the network entity 205-a may reduce the periodicity of the measurement gap configuration, or may refrain from configurating a measurement gap (e.g., the network entity 205-a does not tell the UE 210 to perform any measurements or refrain periodically-scheduled measurements), or may configure an aperiodic measurement gap. If the signal quality at a current location (e.g., location 215-c) is higher than the signal quality at a future location (e.g., location 215-d), then the network entity 205-a may refrain from handing over the UE 210 to the network entity 205-b and signal quality measurements by the UE 210 may be irrelevant. Accordingly, the quantity of measurements performed by the UE 210 may be reduced in such situations.

In some examples, the UE 210 triggers or requests a measurement gap configuration based on obtained location-specific coverage information. In some examples, the network entity 205-a refrains from configuring a measurement gap unless triggered by UE 210. Measurements performed by the UE 210 may confirm coverage information from the external source. In some examples, the network entity 205-a configures a measurement gap, but the measurement gap is ignored by the UE 210. The UE 210 may not perform measurements until the UE 210 requests a measurement gap configuration. In other words, the network entity 205-a may configure a measurement gap without information from the external source, but the UE 210 performs the measurements based on coverage information from the external source. The UE may transmit, to the network entity 205-a, an indication that the UE 210 is not performing the measurements.

By not performing measurements, or by performing less measurements, based on coverage information from the external source, the UE 210 reduces measurement overhead. The network entity 205-a and UE 210 may instead use the resources to continue communication of other signaling and communicate more efficiently, improving user experience.

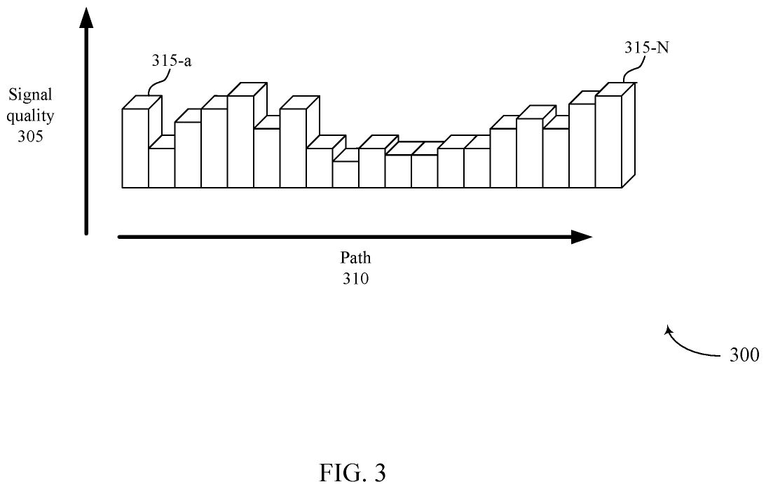

FIG. 3 shows an example of a coverage map 300 that supports reducing UE measurement overhead by using an external source in accordance with one or more aspects of the present disclosure. The coverage map 300 is an example of an external source, which may be stored locally or in a server or in a cloud. Aspects of the coverage map 300 may correspond to other types of external sources, while other aspects may be different. The coverage map 300 may implement or be implemented to realize aspects of the wireless communications system 100, the wireless communications system 200, or both. Locations 315 (e.g., locations 315-a through 315-N) may correspond to locations 215 and may refer to geographical locations (e.g., be geo-tagged).

In some examples, a network entity (such as a network entity 105 or a network entity 205) has access to the external source, in other examples the UE (such as a UE 115 or a UE 210) has access to the external source and may relay coverage information to the network entity. In some examples, both the UE and the network entity have access to the external source. The UE and the network entity may determine which device may access the external source.

The coverage map 300, depicts a general signal quality 305, however, many parameters may be included in the coverage map 300 such as RSRP, RSRQ, SINR, communication statistics (e.g., modulation coding scheme (MCS), user experienced data rate), etc. The location-specific cell coverage information in the coverage map 300 may include a current location of the UE and a predicted future location of the UE.

The path 310 may be an example of the path 220. The UE may, for example, travel from the location 315-a to the location 315-N, traveling through each depicted location between. Each location 315 may be associated with a signal quality. The locations 315 may be sampled locations or may be associated with geo-tagged coverage measurements.

Information in the coverage map 300 may be accessed based on the real-time location (e.g., a location 315) of the UE or path planning (e.g., the path 310 to the destination of the UE, from navigation information). Coverage information associated with the current and future locations of the UE may be determined from the coverage map 300. In some examples, the real-time location of the UE may be based on the UE having global navigation satellite system (GNSS) capability.

The coverage map 300 (e.g., or other external source such as an automotive coverage map or a database) may be a tool for network coverage prediction. For example, the coverage map 300 can have location-specific and time-specific coverage information about the network (e.g., RSRP, RSRQ, CSI, expected user experienced data rate, SINR, corresponding cell information (e.g., cell ID), synchronization signal frequency (e.g., SSB frequency in NR), carrier frequency (e.g., in LTE), subcarrier spacing, etc.). Each location 315 may have specific coverage information. Construction of the coverage map 300 may be based on crowdsourcing of measurements (e.g., RSRP, etc.) or communication performance statistics (e.g., spectral efficiency, data rate, etc.) from the UE, together with UE's location when the measurements were performed. Coverage information from the coverage map 300 may replace some of the measurement mechanisms for the UE. For example, periodical measurements on neighboring cells may be disabled or adjusted to have a larger periodicity.

The coverage map 300 (or other external source) may already contain network coverage information and thus reduce the information gained via UE measurements. The coverage map 300 may contain real-time measurements for other UEs (e.g., vehicles) located at the neighbor cells or contain a coverage pattern learned from past crowdsourced measurements. Coverage map 300 may be an example of automotive connectivity where a vehicle UE's real-time location is available. The coverage information from the coverage map 300 may be used to trigger mobility events (e.g., trigger a measurement report similar to those in NR, such as Event A4, A6, etc.).

In some examples, the UE may obtain information from the coverage map 300 during an absence of an activated measurement gap configuration at the UE. In other words, if the UE does not have a measurement gap configuration, then it may obtain coverage information about the current cell, a neighboring cell, or multiple cells.

Referencing the coverage map 300 to adjust the measurement gap configuration (e.g., reduce the periodicity of the measurement gap, configure to not perform measurements) results in the UE performing less measurements, which results in decreased measurement overhead and increased communication between the serving cell and the UE.

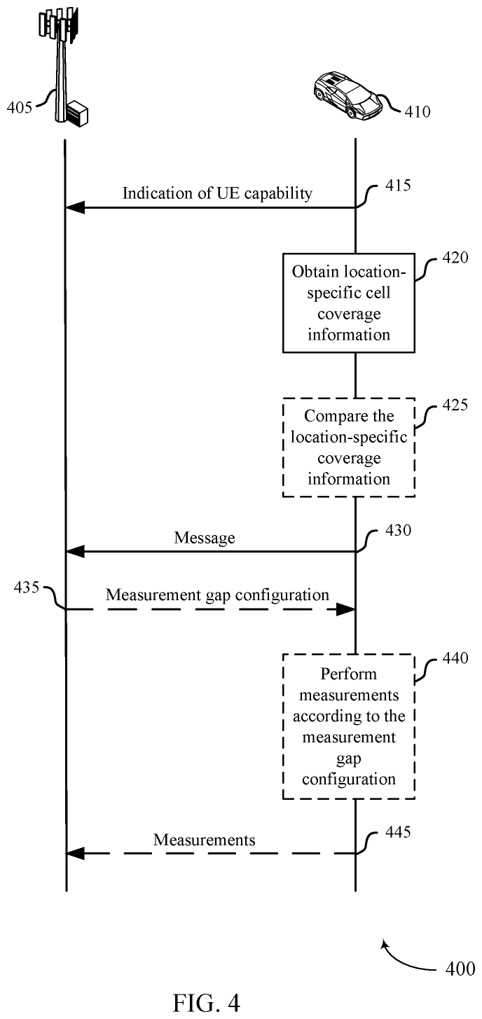

FIG. 4 shows an example of a process flow 400 that supports reducing UE measurement overhead by using an external source in accordance with one or more aspects of the present disclosure. The process flow 400 may implement or be implemented to realize aspects of the wireless communications system 100, the wireless communications system 200, or both. Network entity 405 may be an example of a network entity 205, network entity 105, or both. UE 410 may be an example of a UE 210, a UE 115, or both. The process flow 400 illustrates an example of signaling and other processes that may occur if the UE 410 has access to an external source. The external source may correspond to coverage map 300.

In the following description of the process flow 400, the operations may be performed (such as reported or provided) in a different order than the order shown, or the operations performed by the example devices may be performed in different orders or at different times. For example, specific operations also may be left out of the process flow 400, or other operations may be added to the process flow 400. Further, although some operations or signaling may be shown to occur at different times for discussion purposes, these operations may actually occur at the same time.

At 415, the UE 410 may transmit an indication to the network entity 405. The indication may indicate (e.g., report) a capability of the network to access coverage information from the external source. The indication may indicate an availability of coverage information relevant to a planned (e.g., future) location of the UE 410. In some examples, the UE 410 may transmit (e.g., report) the indication in UE assistance information (UAI), in NR, or in another assistance information format.

At 420, the UE 410 may obtain location-specific cell coverage information from the external source (e.g., a coverage map, a database) based on the capability of the UE 410. In some examples, the UE 410 may determine whether and when to perform measurements based on the coverage information from the external source. The coverage information from the coverage map may be used to trigger mobility events (e.g., trigger a measurement report similar to those in NR, such as Event A4, A6, etc.). The UE 410 may determine to activate a measurement gap.

At 425, the UE 410 may compare location-specific coverage information. The UE 410 may compare coverage information obtained from the external source to coverage information obtained via a measurement by the UE 410. The UE 410 may compare coverage information associated with one cell to coverage information associated with another cell. The UE 410 may compare coverage information, or a derivative of coverage information, to a threshold. For example, the RSRP (obtained from the external source) of the neighboring cell may be higher than the RSRP (obtained from the external source or measured by the UE 410) of the serving cell of the UE 410.

At 430, the UE 410 may transmit, to the network entity 405, a message. The message may be a PHY layer or a MAC layer message. The message may include a request for (e.g., trigger, activate) a measurement gap configuration. The message may indicate a mobility event triggered by the location-specific cell coverage information obtained at 420, by measurements made by the UE 410, or a combination thereof (e.g., a weighted average). The message may include information determined by the UE 410 at 425. The message may include a request for a measurement gap configuration based on the coverage information comparisons done at 425. In some examples, the message is triggered by the UE 410 determining to perform a measurement based on coverage information from the external source. For example, coverage information may indicate that a neighbor cell's signal quality (e.g., RSRP) satisfies a threshold (e.g., is higher than the RSRP of the cell in which the UE 410 is located by an offset). If the signal quality of the neighbor cell satisfies the threshold, then the UE 410 may transmit, at 430, an indication to the network entity 405 to trigger a measurement configuration for the neighbor cell. In other words, UE 410 may use the coverage information from the external source as a reference to trigger the UE 410 measurements.

At 435, the network entity 405 may transmit (e.g., via RRC signaling, for measurement object) a measurement gap configuration to the UE 410. In some examples, the network entity 405 may configure the UE 410 measurement gap with a different configuration based on the coverage information from the external source. The network entity 405 may trigger a measurement gap configuration in accordance with a previously or already configured measurement gap configuration. In some examples, the network entity 405 may determine whether and how to perform measurements based on the coverage information from the external source as indicated by the UE 410. In some examples, the network entity 405 may configure the measurement gap (e.g., whether and when to perform measurements based on the coverage information) based on a determination made by the UE 410 (e.g., the determination made by the UE 410 is based on the coverage information from the external source). The measurement gap configuration may be an updated measurement gap configuration (e.g., the UE 410 was operating with a different measurement gap configuration prior to 435) or may be a new measurement gap configuration (e.g., there was no measurement gap configuration prior to 435). The network entity 405 may configure the measurement gap configuration to include a larger periodicity, a smaller periodicity, include aperiodic measurements, or to not perform any measurements.

In some examples, the network entity 405 may configure the measurement gap such that the UE 410 refrains from measuring a neighboring cell (e.g., corresponding to a future location of the UE 410) or from performing periodically-scheduled measurements. In other words, the network entity 405 may refrain from transmitting or configuring a measurement gap (e.g., based on the comparisons at 425). The UE 410 may already have (e.g., via the external source) coverage information corresponding to the neighboring cell and thus any measurements may be redundant. In this example, the coverage information measured by the UE 410 may confirm the coverage information from the external source. The network entity 405 may not configure a measurement gap configuration unless the UE 410 triggers a configuration.

At 440, the UE 410 may perform one or more measurements according to the measurement gap configuration transmitted at 435. The UE 410 may use the measurements for UE 410 mobility purposes (e.g., determining whether to report the measurement to the network entity 405).

At 445, the UE 410 may transmit, to the network entity 405, data associated with the one or more measurements performed at 440. The UE 410 may use coverage information from the coverage map or measured coverage information from UE 410 to trigger mobility events (e.g., trigger a measurement report). In some examples, both (e.g., a weighted average of) the coverage information from the coverage map and measured coverage information from UE 410 to trigger mobility events.

Referencing the external source to adjust the measurement gap configuration (e.g., reduce the periodicity of the measurement gap, configure to not perform measurements) results in the UE 410 performing less measurements, which results in decreased measurement overhead and increased communication between the network entity 405 and the UE 410. Reduced measurement overhead may be achieved while maintaining adequate coverage and reducing power consumption. The increased (e.g., uninterrupted or less interrupted) communication between the network entity 405 and the UE 410 reduces latency and improves user experience.

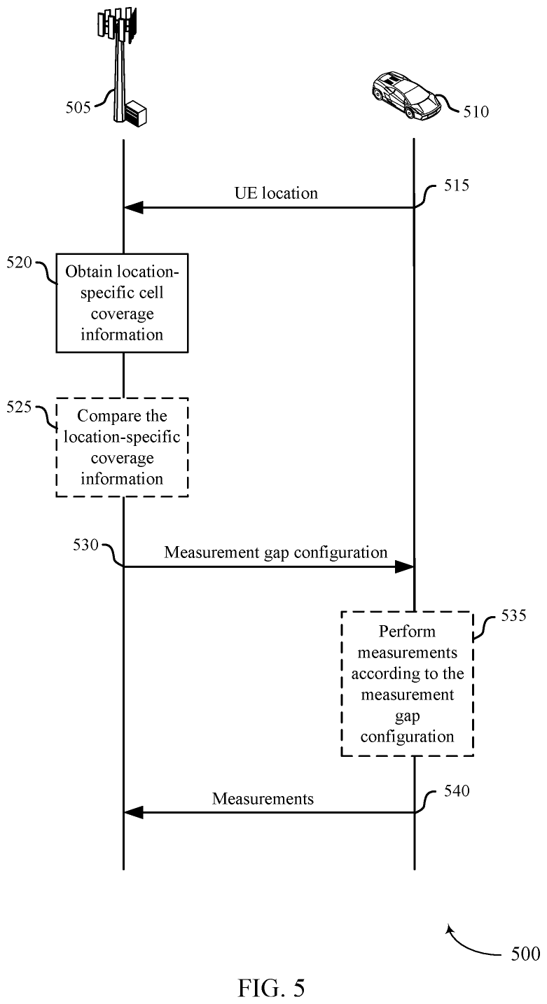

FIG. 5 shows an example of a process flow 500 that supports reducing UE measurement overhead by using an external source in accordance with one or more aspects of the present disclosure. The process flow 400 may implement or be implemented to realize aspects of the wireless communications system 100, the wireless communications system 200, or both. Network entity 505 may be an example of a network entity 205, network entity 105, or both. UE 510 may be an example of a UE 210, a UE 115, or both. The UE 510 may be a vehicle, mobile device, or other type of UE. The process flow 500 illustrates an example of signaling and other processes that may occur if the network entity 505 has access to an external source. The external source may correspond to coverage map 300. Some aspects of both the process flow 400 and the process flow 500 may be incorporated together to create a single process.

In the following description of the process flow 500, the operations may be performed (such as reported or provided) in a different order than the order shown, or the operations performed by the example devices may be performed in different orders or at different times. For example, specific operations also may be left out of the process flow 500, or other operations may be added to the process flow 500. Further, although some operations or signaling may be shown to occur at different times for discussion purposes, these operations may actually occur at the same time.

At 515, the UE 510 may transmit, to the network entity 505, an indication of a current location of the UE 510. The UE 510 may also transmit an indication of a future location (e.g., navigation information) of the UE 510. The future location of the UE 510 may correspond to a neighboring cell (e.g., a cell associated with a network entity that is not the network entity 505). In some examples, the UE 510 may transmit a current location or a future location periodically.

At 520, the network entity 505 may obtain location-specific cell coverage information from the external source (e.g., a coverage map, a database) corresponding to the location of the neighboring cell of the UE 510. The network entity 505 may obtain location-specific cell coverage information from the external source corresponding to multiple locations associated with a path of the UE 510 (e.g., including information associated with a current location of the UE 510, with multiple neighboring cells, etc.). In some examples, the network entity 505 may determine whether and when to configure the UE 510 to perform measurements (e.g., configure the measurement gap) based on the coverage information from the external source.

At 525, the network entity 505 may compare location-specific coverage information. The network entity 505 may compare coverage information obtained from the external source to coverage information obtained via a measurement by the UE 510. The network entity 505 may compare coverage information associated with one cell to coverage information associated with another cell. The network entity 505 may compare coverage information, or a derivative of coverage information, to a threshold. When the coverage information from the external source meets a condition, the network entity 505 may activate a measurement of the UE 510. The activated measurement, (e.g., a measurement done by the UE 510 rather than obtained via the external source) may confirm that the neighbor cell has higher coverage than the current cell. For example, the RSRP (obtained from the external source) of the neighboring cell may be higher than the RSRP (obtained from the external source or measured by the UE 510) of the serving cell of the UE 510. The network entity 505, based on the relative RSRP values, may configure (e.g., trigger) the UE 510 to perform at least one measurement on the neighbor cell, to perform at least one measurement on the current serving cell, to perform at least one measurement on multiple cells, or to refrain from performing measurements.

At 530, the network entity 505 may transmit (e.g., via RRC signaling), to the UE 510, a measurement gap configuration. The network entity 505 may trigger the UE 510 to perform a measurement (e.g., activate measurements based on a measurement configuration that is already configured). The measurement gap configuration may have an adjusted periodicity relative to a previous measurement gap configuration (e.g., larger periodicity, smaller periodicity, aperiodicity). The network entity 505 may refrain from transmitting, to the UE 510 a measurement gap configuration (e.g., based on the comparisons at 525).

At 535, the UE 510 may perform one or more measurements according to the configuration set by the network entity 505.

At 540, the UE 510 may transmit, to the network entity 505, data associated with the one or more measurements performed at 535. The network entity 505 may compare the data associated with the one or more measurements to the location-specific cell coverage information from the external source.

Referencing the external source to adjust the measurement gap configuration (e.g., reduce the periodicity of the measurement gap, configure to not perform measurements) results in the UE 510 performing less measurements, which results in decreased measurement overhead and increased communication between the network entity 505 and the UE 510. Reduced measurement overhead may be achieved while maintaining adequate coverage and reducing power consumption. The increased (e.g., uninterrupted or less interrupted) communication between the network entity 505 and the UE 510 reduces latency and improves user experience.

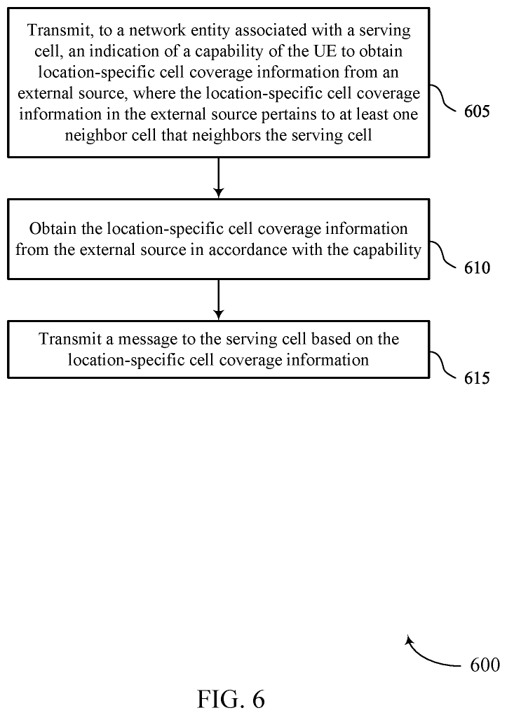

FIG. 6 shows a flowchart illustrating a method 600 that supports reducing UE measurement overhead by using an external source in accordance with aspects of the present disclosure. The operations of the method 600 may be implemented by a UE or its components as described herein. For example, the operations of the method 600 may be performed by a UE. In some examples, the UE may execute a set of instructions to control the functional elements of the UE to perform the described functions. Additionally, or alternatively, the UE may perform aspects of the described functions using special-purpose hardware.

At 605, the method may include transmitting, to a network entity associated with a serving cell, an indication of a capability of the UE to obtain location-specific cell coverage information from an external source, where the location-specific cell coverage information in the external source pertains to at least one neighbor cell that neighbors the serving cell. The operations of block 605 may be performed in accordance with examples as disclosed herein.

At 610, the method may include obtaining the location-specific cell coverage information from the external source in accordance with the capability. The operations of block 610 may be performed in accordance with examples as disclosed herein.

At 615, the method may include transmitting a message to the serving cell based on the location-specific cell coverage information. The operations of block 615 may be performed in accordance with examples as disclosed herein.

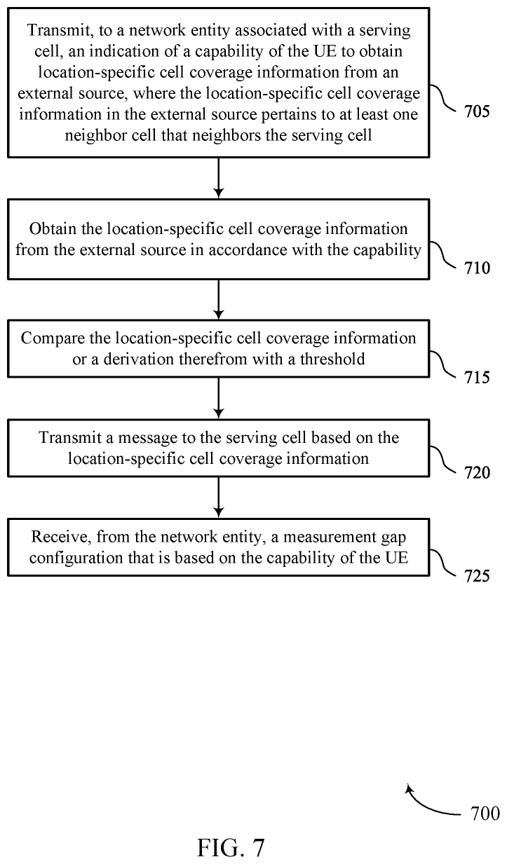

FIG. 7 shows a flowchart illustrating a method 700 that supports reducing UE measurement overhead by using an external source in accordance with aspects of the present disclosure. The operations of the method 700 may be implemented by a UE or its components as described herein. In some examples, the UE may execute a set of instructions to control the functional elements of the UE to perform the described functions. Additionally, or alternatively, the UE may perform aspects of the described functions using special-purpose hardware.

At 705, the method may include transmitting, to a network entity associated with a serving cell, an indication of a capability of the UE to obtain location-specific cell coverage information from an external source, where the location-specific cell coverage information in the external source pertains to at least one neighbor cell that neighbors the serving cell. The operations of block 705 may be performed in accordance with examples as disclosed herein.

At 710, the method may include obtaining the location-specific cell coverage information from the external source in accordance with the capability. The method may include transmitting UE assistance information that includes the indication. The operations of block 710 may be performed in accordance with examples as disclosed herein.

At 715, the method may include comparing the location-specific cell coverage information or a derivation therefrom with a threshold. The operations of block 715 may be performed in accordance with examples as disclosed herein.

At 720, the method may include transmitting a message to the serving cell based on the location-specific cell coverage information. The operations of block 720 may be performed in accordance with examples as disclosed herein.

At 725, the method may include receiving, from the network entity, a measurement gap configuration that is based on the capability of the UE. The operations of block 725 may be performed in accordance with examples as disclosed herein.

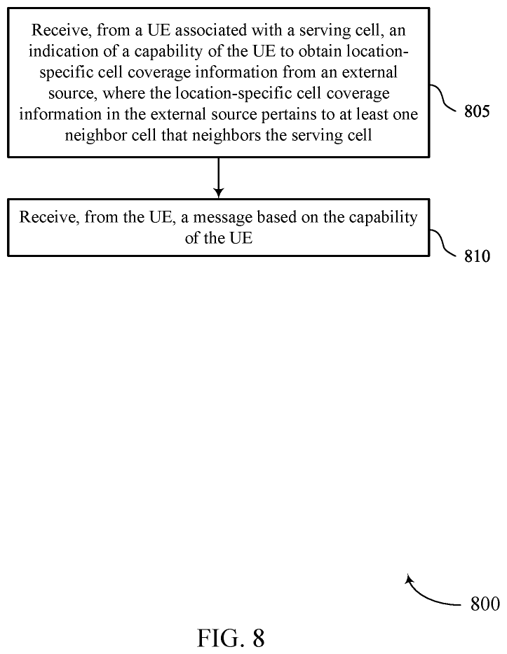

FIG. 8 shows a flowchart illustrating a method 800 that supports reducing UE measurement overhead by using an external source in accordance with aspects of the present disclosure. The operations of the method 800 may be implemented by a network entity or its components as described herein. In some examples, the network entity may execute a set of instructions to control the functional elements of the network entity to perform the described functions. Additionally, or alternatively, the network entity may perform aspects of the described functions using special-purpose hardware.

At 805, the method may include receiving, from a UE associated with a serving cell, an indication of a capability of the UE to obtain location-specific cell coverage information from an external source, where the location-specific cell coverage information in the external source pertains to at least one neighbor cell that neighbors the serving cell. The operations of block 805 may be performed in accordance with examples as disclosed herein.

At 810, the method may include receiving, from the UE, a message based on the capability of the UE. The operations of block 810 may be performed in accordance with examples as disclosed herein.

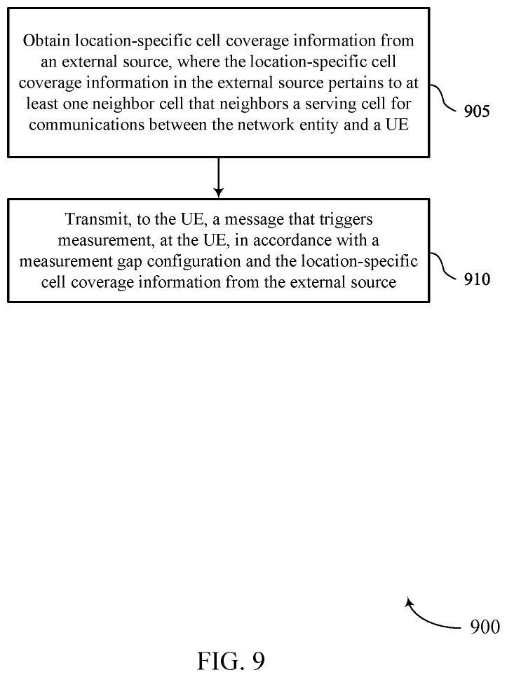

FIG. 9 shows a flowchart illustrating a method 900 that supports reducing UE measurement overhead by using an external source in accordance with aspects of the present disclosure. The operations of the method 900 may be implemented by a network entity or its components as described herein. For example, the operations of the method 900 may be performed by the network entity. In some examples, the network entity may execute a set of instructions to control the functional elements of the network entity to perform the described functions. Additionally, or alternatively, the network entity may perform aspects of the described functions using special-purpose hardware.

At 905, the method may include obtaining location-specific cell coverage information from an external source, where the location-specific cell coverage information in the external source pertains to at least one neighbor cell that neighbors a serving cell for communications between the network entity and a UE. The operations of block 905 may be performed in accordance with examples as disclosed herein.

At 910, the method may include transmitting, to the UE, a message that triggers measurement, at the UE, in accordance with a measurement gap configuration and the location-specific cell coverage information from the external source. The operations of block 910 may be performed in accordance with examples as disclosed herein.

The following aspects are given by way of illustration. Examples of the following aspects may be combined with examples or embodiments shown or discussed in relation to the figures or elsewhere herein.
Aspect 1: A method for wireless communications at a UE, comprising: transmitting, to a network entity associated with a serving cell, an indication of a capability of the UE to obtain location-specific cell coverage information from an external source, wherein the location-specific cell coverage information in the external source pertains to at least one neighbor cell that neighbors the serving cell; obtaining the location-specific cell coverage information from the external source in accordance with the capability; and transmitting a message to the serving cell based at least in part on the location-specific cell coverage information.
Aspect 2: The method of aspect 1, wherein the external source is a coverage map or a database and is stored locally or in a server.
Aspect 3: The method of any of aspects 1 through 2, wherein transmitting the indication of the capability of the UE comprises: transmitting UE assistance information that includes the indication.
Aspect 4: The method of any of aspects 1 through 3, wherein the location-specific cell coverage information is obtained from the external source in an absence of an activated measurement gap configuration at the UE.
Aspect 5: The method of aspect 4, wherein the message transmitted to the serving cell is indicative of a mobility event triggered by the location-specific cell coverage information.
Aspect 6: The method of any of aspects 1 through 5, further comprising: receiving, from the network entity, a measurement gap configuration that is based at least in part on the capability of the UE.
Aspect 7: The method of aspect 6, wherein the measurement gap configuration includes a measurement periodicity that is based on the capability of the UE.
Aspect 8: The method of aspect 6, wherein the measurement gap configuration indicates that UE measurements are aperiodic, based on the capability of the UE.
Aspect 9: The method of any of aspects 6 through 8, wherein the message transmitted to the serving cell is indicative of a mobility event triggered by measurements made by the UE in accordance with the measurement gap configuration or triggered by a combination of the measurements and the location-specific cell coverage information.
Aspect 10: The method of aspect 9, wherein the combination is a weighted average of the measurements and the location-specific cell coverage information.
Aspect 11: The method of any of aspects 1 through 10, wherein the at least one neighbor cell is, with respect to the serving cell, an intra- or an inter-frequency cell, or an intra- or an inter-radio access technology (RAT) cell.
Aspect 12: The method of any of aspects 1 through 11, further comprising: comparing the location-specific cell coverage information or a derivation therefrom with a threshold.
Aspect 13: The method of aspect 12, wherein the message transmitted to the serving cell is a request for a measurement gap configuration, transmission of the request based at least in part on the comparison.
Aspect 14: The method of any of aspects 12 through 13, further comprising: receiving, from the network entity and via radio resource control messaging, a measurement gap configuration, wherein the message transmitted to the serving cell is a request for activation of the measurement gap configuration, transmission of the request based at least in part on the comparison.
Aspect 15: The method of any of aspects 12 through 14, wherein the comparison is between the threshold and an offset between a neighbor signal quality of the at least one neighbor cell and a serving signal quality of the serving cell.
Aspect 16: The method of any of aspects 1 through 15, wherein the location-specific cell coverage information in the external source includes a current location of the UE and a predicted future location of the UE.
Aspect 17: The method of any of aspects 1 through 16, wherein the location-specific cell coverage information includes, for specific locations, one or more of a reference signal received power, a reference signal received quality, a signal to interference plus noise ratio, cell information of a cell associated with a location of the UE including one or more of synchronization signal frequency, carrier frequency, or subcarrier spacing.
Aspect 18: The method of any of aspects 1 through 17, further comprising: refraining from performance of periodically-scheduled measurements based at least in part on the capability of the UE and on the location-specific cell coverage information.
Aspect 19: The method of any of aspects 1 through 18, wherein the UE is a vehicle.
Aspect 20: The method of any of aspects 1 through 19, wherein the message triggers or activates a measurement gap configuration, and the message is a physical (PHY) layer or medium access control (MAC) layer message.
Aspect 21: A method for wireless communications at a network entity, comprising: receiving, from a UE associated with a serving cell, an indication of a capability of the UE to obtain location-specific cell coverage information from an external source, wherein the location-specific cell coverage information in the external source pertains to at least one neighbor cell that neighbors the serving cell; and receiving, from the UE, a message based at least in part on the capability of the UE.
Aspect 22: The method of aspect 21, wherein receiving the indication of the capability of the UE comprises: receiving UE assistance information that includes the indication.
Aspect 23: The method of any of aspects 21 through 22, further comprising: transmitting, to the UE, a measurement gap configuration that is based at least in part on the capability of the UE.
Aspect 24: The method of aspect 23, wherein the measurement gap configuration includes a measurement periodicity that is based on the capability of the UE.
Aspect 25: The method of aspect 23, wherein the measurement gap configuration indicates that UE measurements are aperiodic, based on the capability of the UE.
Aspect 26: The method of any of aspects 23 through 25, wherein the message received from the UE is indicative of a mobility event triggered by measurements made by the UE in accordance with the measurement gap configuration or triggered by a combination of the measurements and the location-specific cell coverage information.
Aspect 27: The method of aspect 26, wherein the combination is a weighted average of the measurements and the location-specific cell coverage information.
Aspect 28: The method of any of aspects 21 through 27, wherein the at least one neighbor cell is, with respect to the serving cell, an intra- or an inter-frequency cell, or an intra- or an inter-radio access technology (RAT) cell.
Aspect 29: The method of any of aspects 21 through 28, wherein the message triggers or activates a measurement gap configuration, and the message is a physical (PHY) layer or medium access control (MAC) layer message.
Aspect 30: A method for wireless communications at a network entity, comprising: obtaining location-specific cell coverage information from an external source, wherein the location-specific cell coverage information in the external source pertains to at least one neighbor cell that neighbors a serving cell for communications between the network entity and a UE; and transmitting, to the UE, a message that triggers measurement, at the UE, in accordance with a measurement gap configuration and the location-specific cell coverage information from the external source.
Aspect 31: The method of aspect 30, further comprising: receiving an indication of a location of the UE, wherein the location-specific cell coverage information from the external source is obtained based at least in part on the location of the UE or on a predicted future location of the UE.
Aspect 32: The method of any of aspects 30 through 31, further comprising: determining that a difference between location-specific cell coverage information pertaining to the serving cell and the location-specific cell coverage information associated with the at least one neighbor cell satisfies a threshold; and refraining from transmitting, to the UE, a second measurement gap configuration based at least in part on the determination.
Aspect 33: The method of any of aspects 30 through 32, wherein the message triggers the UE to perform measurements in accordance with an already configured measurement gap configuration.
Aspect 34: The method of aspect 33, further comprising: receiving, in response to the message, one or more measurements from the UE, wherein the one or more measurements are compared with the location-specific cell coverage information.
Aspect 35: The method of any of aspects 30 through 34, wherein the message includes a measurement gap configuration that is based at least in part on the location-specific cell coverage information in the external source.
Aspect 36: A UE comprising one or more memories storing processor-executable code, and one or more processors coupled with the one or more memories and individually or collectively operable to execute the code to cause the UE to perform a method of any of aspects 1 through 20.
Aspect 37: A UE comprising at least one means for performing a method of any of aspects 1 through 20.
Aspect 38: A non-transitory computer-readable medium storing code the code comprising instructions executable by a processor to perform a method of any of aspects 1 through 20.
Aspect 39: A network entity comprising one or more memories storing processor-executable code, and one or more processors coupled with the one or more memories and individually or collectively operable to execute the code to cause the network entity to perform a method of any of aspects 21 through 29.
Aspect 40: A network entity comprising at least one means for performing a method of any of aspects 21 through 29.
Aspect 41: A non-transitory computer-readable medium storing code the code comprising instructions executable by a processor to perform a method of any of aspects 21 through 29.
Aspect 42: A network entity comprising one or more memories storing processor-executable code, and one or more processors coupled with the one or more memories and individually or collectively operable to execute the code to cause the network entity to perform a method of any of aspects 30 through 35.
Aspect 43: A network entity comprising at least one means for performing a method of any of aspects 30 through 35.
Aspect 44: A non-transitory computer-readable medium storing code the code comprising instructions executable by a processor to perform a method of any of aspects 30 through 35.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit, to a network entity associated with a serving cell, an indication of a capability of the UE to obtain location-specific cell coverage information from an external source, wherein the location-specific cell coverage information in the external source pertains to at least one neighbor cell that neighbors the serving cell;
obtain the location-specific cell coverage information from the external source in accordance with the capability; and
transmit a message to the serving cell based at least in part on the location-specific cell coverage information.

2. The UE of claim 1, wherein the external source is a coverage map or a database and is stored locally or in a server.

3. The UE of claim 1, wherein, to transmit the indication of the capability of the UE, the one or more processors are individually or collectively operable to execute the code to cause the UE to:
transmit UE assistance information that includes the indication.

4. The UE of claim 1, wherein the location-specific cell coverage information is obtained from the external source in an absence of an activated measurement gap configuration at the UE.

5. The UE of claim 4, wherein the message transmitted to the serving cell is indicative of a mobility event triggered by the location-specific cell coverage information.

6. The UE of claim 1, wherein the one or more processors are individually or collectively further operable to execute the code to cause the UE to:
receive, from the network entity, a measurement gap configuration that is based at least in part on the capability of the UE.

7. The UE of claim 6, wherein the measurement gap configuration includes a measurement periodicity that is based on the capability of the UE.

8. The UE of claim 6, wherein the measurement gap configuration indicates that UE measurements are aperiodic, based on the capability of the UE.

9. The UE of claim 6, wherein the message transmitted to the serving cell is indicative of a mobility event triggered by measurements made by the UE in accordance with the measurement gap configuration or triggered by a combination of the measurements and the location-specific cell coverage information.

10. The UE of claim 9, wherein the combination is a weighted average of the measurements and the location-specific cell coverage information.

11. The UE of claim 1, wherein the one or more processors are individually or collectively further operable to execute the code to cause the UE to:
compare the location-specific cell coverage information or a derivation therefrom with a threshold.

12. The UE of claim 11, wherein the message transmitted to the serving cell is a request for a measurement gap configuration, transmission of the request based at least in part on the comparison.

13. The UE of claim 11, wherein the one or more processors are individually or collectively further operable to execute the code to cause the UE to:
receive, from the network entity and via radio resource control messaging, a measurement gap configuration, wherein the message transmitted to the serving cell is a request for activation of the measurement gap configuration, transmission of the request based at least in part on the comparison.

14. The UE of claim 11, wherein the comparison is between the threshold and an offset between a neighbor signal quality of the at least one neighbor cell and a serving signal quality of the serving cell.

15. The UE of claim 1, wherein the location-specific cell coverage information in the external source includes a current location of the UE and a predicted future location of the UE.

16. The UE of claim 1, wherein the location-specific cell coverage information includes, for specific locations, one or more of a reference signal received power, a reference signal received quality, a signal to interference plus noise ratio, cell information of a cell associated with a location of the UE including one or more of synchronization signal frequency, carrier frequency, or subcarrier spacing.

17. The UE of claim 1, wherein the one or more processors are individually or collectively further operable to execute the code to cause the UE to:
refrain from performance of periodically-scheduled measurements based at least in part on the capability of the UE and on the location-specific cell coverage information.

18. A network entity, comprising:
one or more memories storing processor-executable code; and
one or more processors coupled with the one or more memories and individually or collectively operable to execute the code to cause the network entity to:
receive, from a UE associated with a serving cell, an indication of a capability of the UE to obtain location-specific cell coverage information from an external source, wherein the location-specific cell coverage information in the external source pertains to at least one neighbor cell that neighbors the serving cell; and
receive, from the UE, a message based at least in part on the capability of the UE.

19. The network entity of claim 18, wherein, to receive the indication of the capability of the UE, the one or more processors are individually or collectively operable to execute the code to cause the network entity to:
receive UE assistance information that includes the indication.

20. The network entity of claim 18, wherein the one or more processors are individually or collectively further operable to execute the code to cause the network entity to:
transmit, to the UE, a measurement gap configuration that is based at least in part on the capability of the UE.

21. A network entity, comprising:
one or more memories storing processor-executable code; and
one or more processors coupled with the one or more memories and individually or collectively operable to execute the code to cause the network entity to:
obtain location-specific cell coverage information from an external source, wherein the location-specific cell coverage information in the external source pertains to at least one neighbor cell that neighbors a serving cell for communications between the network entity and a user equipment (UE); and
transmit, to the UE, a message that triggers measurement, at the UE, in accordance with a measurement gap configuration and the location-specific cell coverage information from the external source.

22. The network entity of claim 21, wherein the one or more processors are individually or collectively further operable to execute the code to cause the network entity to:
receive an indication of a location of the UE, wherein the location-specific cell coverage information from the external source is obtained based at least in part on the location of the UE or on a predicted future location of the UE.

23. The network entity of claim 21, wherein the one or more processors are individually or collectively further operable to execute the code to cause the network entity to:
determine that a difference between location-specific cell coverage information associated with the serving cell and the location-specific cell coverage information pertaining to the at least one neighbor cell satisfies a threshold; and
refrain from transmitting, to the UE, a second measurement gap configuration based at least in part on the determination.

24. The network entity of claim 21, wherein the message triggers the UE to perform measurements in accordance with an already configured measurement gap configuration.

25. A method for wireless communications at a user equipment (UE), comprising:
transmitting, to a network entity associated with a serving cell, an indication of a capability of the UE to obtain location-specific cell coverage information from an external source, wherein the location-specific cell coverage information in the external source pertains to at least one neighbor cell that neighbors the serving cell;
obtaining the location-specific cell coverage information from the external source in accordance with the capability; and
transmitting a message to the serving cell based at least in part on the location-specific cell coverage information.

26. The method of claim 25, wherein the external source is a coverage map or a database and is stored locally or in a server.

27. The method of claim 25, wherein transmitting the indication of the capability of the UE comprises:
transmitting UE assistance information that includes the indication.

28. The method of claim 25, wherein the location-specific cell coverage information is obtained from the external source in an absence of an activated measurement gap configuration at the UE.

29. The method of claim 28, wherein the message transmitted to the serving cell is indicative of a mobility event triggered by the location-specific cell coverage information.

30. The method of claim 25, further comprising:
receiving, from the network entity, a measurement gap configuration that is based at least in part on the capability of the UE.
